(19) United States
(12) Patent Application Publication
(10) Pub. No.: US 2013/0003159 A1
(43) Pub. Date: Jan. 3, 2013

(54) BISTABLE PHOTONIC CRYSTAL

(75) Inventors: Jer-Liang Yeh, Hsinchu City (TW); Chia-Tsung Chan, Hsinchu City (TW)

(73) Assignee: NATIONAL TSING HUA UNIVERSITY, Hsinchu (TW)

(21) Appl. No.: 13/535,910

(22) Filed: Jun. 28, 2012

(30) Foreign Application Priority Data
Jun. 30, 2011 (TW) 100123059

(51) Int. Cl. G02F 1/01; B82Y 20/00

(52) U.S. Cl. 359/290; 977/834

(57) ABSTRACT

The present invention is to provide a bistable photonic crystal. The photonic crystal has a plurality of voids. Each surface of void has a hydrophobic film. When the photonic crystal is immersed in a predetermined liquid, the photonic crystal has a first stable state and a second stable state. Wherein, the first stable state is to fill the plurality of voids with the predetermined liquid, and the second stable state is to exclude the predetermined liquid from the plurality of voids. Owing to the energy barrier between the first and second stable states, the photonic crystal can remain at either of the two states without external power consumption.

### BACKGROUND OF THE INVENTION

1. Field of the Invention

The present invention relates to a bistable photonic crystal, and more particularly to a photonic crystal which can remain at either of the two stable states without external power consumption.

2. Description of the Prior Art

Photonic crystal is a nanostructure with refractive index periodic arrangement, which can the propagation and transmission properties of light. Meanwhile, photonic crystal is a good candidate material for future optical elements, such as optical communication, display device and optical computer. Recently, the fabrication process, the tunable method and the driving pattern for photonic crystal continue to be important aims for the development of photonic crystal. In conventional method, the tunable photonic crystals generate color variation by electrochemistry method. However, the conventional method of tunable photonic crystal are limited to the liquid diffusion velocity (˜10⁻³ m/s) and the selection of material, leading to the difficulty of achieving fast response time and wide color variation at the same time.

In addition, some conventional tunable photonic crystals apply dilatation, contracting elastic polymer, or modifying periodicity with magnetism to achieve a tunable range of wavelength in excess of 10 nanometer (nm), however, these conventional tunable photonic crystals have relevance with the transport mechanism of fluid, causing the response time to be at least 1 second above. On the contrary, the conventional tunable photonic crystals whose response time are below 10 millisecond (ms) have the mechanism of manipulating anisotropic materials electrically, but the anisotropy of materials limit the tunable range of wavelength below 2 nm. That is to say, no tunable photonic crystals in the prior art can achieve both fast response time and wide tunable range of wavelength at the same time.

Therefore, how to develop a photonic crystal which can achieve fast response time and wide tunable range of wavelength, and meanwhile, remain at a stable state without external power consumption is the primary topic in this field.

### SUMMARY OF THE INVENTION

Therefore, in order to improve the problem described previously, a scope of the present invention is to provide a bistable photonic crystal which has a plurality of voids and each surface of void has a hydrophobic film. When the photonic crystal is immersed in a predetermined liquid, the photonic crystal has a first stable state and a second stable state. Wherein, the first stable state is to fill the plurality of voids with the predetermined liquid, and the second stable state is to exclude the predetermined liquid from the plurality of voids.

According to an embodiment, the photonic crystal comprises a surface, and the first stable state is to fill the plurality of voids with the predetermined liquid by coating a first liquid on the surface of the photonic crystal, and the surface tension of the first liquid is less than the surface tension of the predetermined liquid. Additionally, the second stable state is to exclude the predetermined liquid from the plurality of voids by coating a second liquid on the surface of the photonic crystal, and the surface tension of the second liquid is greater than the surface tension of the predetermined liquid.

In actual application, the predetermined liquid can be a 30 wt % ethanol aqueous solution, the first liquid can be a 99.5 wt % ethanol aqueous solution, and the second liquid can be pure water.

Accordingly, the photonic crystal of present invention applies the variation of capillary pressure generated by displacing different fluids to form the bidirectional flow for adjusting the liquid proportion within the voids. Meanwhile, the equivalent refractive index of the voids would be changed, and influencing the reflection and transmission spectra of photonic crystal, so that the color of photonic crystal can be changed widely and rapidly. Furthermore, owing to the energy barrier between the first and second stable states, the photonic crystal can remain at either of the two states without external power consumption.

Many other advantages and features of the present invention will be further understood by the detailed description and the accompanying sheet of drawings.

### BRIEF DESCRIPTION OF THE APPENDED DRAWINGS

FIG. 1 is a schematic diagram illustrating a first liquid coated on the surface of the photonic crystal according to the invention.

FIG. 2 is a schematic diagram illustrating a second liquid coated on the surface of the photonic crystal according to the invention.

FIG. 3 is a scanning electron micrograph (SEM) image demonstrating a cross-section of the photonic crystal according to the invention.

FIG. 4 is a comparison table illustrating the tunable photonic crystal (PhC) method.

To facilitate understanding, identical reference numerals have been used, where possible to designate identical elements that are common to the figures.

### DETAILED DESCRIPTION OF THE INVENTION

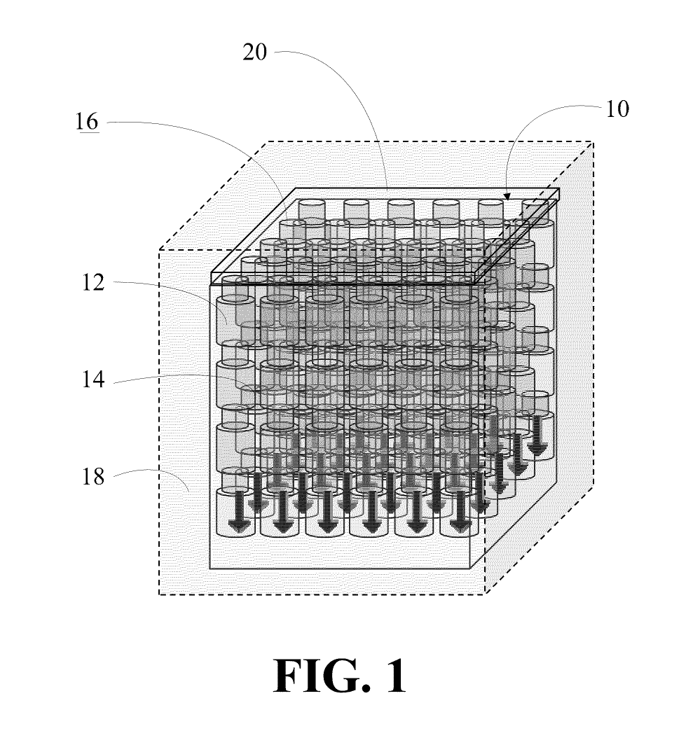

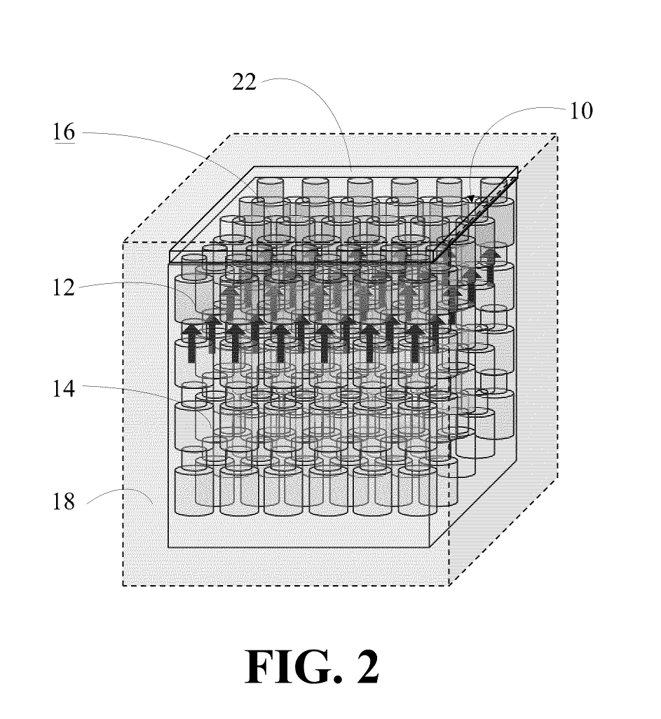

Please refer to FIG. 1 and FIG. 2. FIG. 1 is a schematic diagram illustrating a first liquid coated on the surface of the photonic crystal according to the invention; and FIG. 2 is a schematic diagram illustrating a second liquid coated on the surface of the photonic crystal according to the invention. The present invention provides a bistable photonic crystal 10 which has a plurality of voids 12 and each surface of void 12 has a hydrophobic film 14. When the photonic crystal 10 is immersed in a predetermined liquid 18, the photonic crystal 10 has a first stable state and a second stable state. Wherein, the first stable state is to fill the plurality of voids 12 with the predetermined liquid 18, and the second stable state is to exclude the predetermined liquid 18 from the plurality of voids 12.

According to an embodiment, the photonic crystal 10 comprises a surface 16, and the first stable state is to fill the plurality of voids 12 with the predetermined liquid 18 by coating a first liquid 20 on the surface 16 of the photonic crystal 10 (as shown in FIG. 1), and the surface tension of the first liquid 20 is less than the surface tension of the predetermined liquid 18. Additionally, the second stable state is to exclude the predetermined liquid 18 from the plurality of voids 12 by coating a second liquid 22 on the surface 16 of the photonic crystal 10 (as shown in FIG. 2), and the surface tension of the second liquid 22 is greater than the surface tension of the predetermined liquid 18. In actual practice of the invention for silicon-based visible photonic crystals, the voids comprise a plurality of big voids and a plurality of small voids. The size of the small voids ranges from 4 nm to 6 nm. The size of the big voids ranges from 10 nm to 15 nm.

According to an embodiment, the predetermined liquid 18, the first liquid 20, and the second liquid 22 of the present invention can be a polar liquid or a nonpolar liquid, such as: water, alcohols, colloids, surfactants, or ionic liquids. Moreover, the predetermined liquid 18, the first liquid 20, and the second liquid 22 can be binary liquid mixtures or alcohol-water mixtures with different mass concentrations respectively.

In actual application, the present invention employs a 30 wt % ethanol aqueous solution as the predetermined liquid 18, a 99.5 wt % ethanol aqueous solution as the first liquid 20, and pure water as the second liquid 22. Additionally, these liquids can illustrate the working principles of the photonic crystal 10 at the first and second stable state.

Please refer to FIG. 1 again. First, immersing the photonic crystals 10 whose voids 12 have air in 30 wt % ethanol aqueous solution; next, coating a film of 99.5 wt % ethanol aqueous solution on the surface 16 of the photonic crystals 10; afterward, the low surface tension ethanol film induces capillary attraction, which allows the 30 wt % ethanol aqueous solution to be imbibed into the photonic crystals 10; subsequently, the 30 wt % ethanol aqueous solution diffuses until a concentration equilibrium is achieved; finally, the plurality of voids 12 would be filled with the 30 wt % ethanol aqueous solution, i.e., the photonic crystals 10 would be at the first stable state.

Please refer to FIG. 2. First, coating a film of pure water on the surface 16 of the photonic crystals 10; and then, the high surface tension pure water diffuses into the inside of the photonic crystals 10 until a concentration equilibrium is achieved; afterward, the increase of the water content inside the photonic crystals 10 leads to the increase of the surface tension, and induces capillary repulsion, which allows the 30 wt % ethanol aqueous solution to be excluded from the voids 12 of the photonic crystals 10; finally, the plurality of voids 12 would be filled with air, i.e., the photonic crystals 10 would be at the second stable state.

Due to the variation of the predetermined liquid 18 proportion within the voids 12, the refractive index of the voids 12 would be changed, and leading to the color variation of photonic crystal 10. In addition, owing to the energy barrier between the first and second stable states, the photonic crystal 10 can remain at either of the two states without external power consumption.

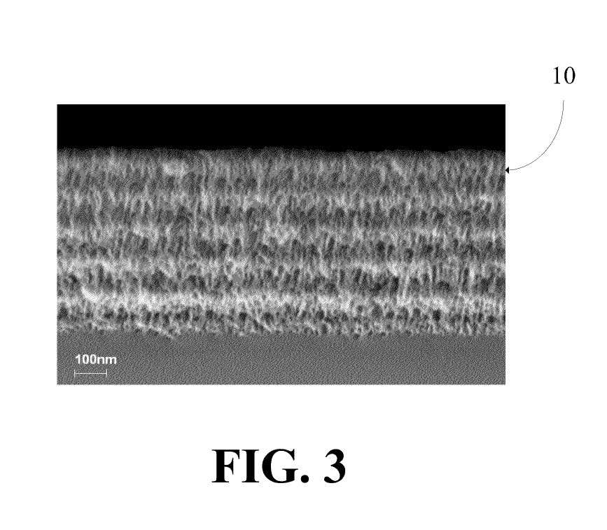

Please refer to FIG. 3. FIG. 3 is a scanning electron micrograph (SEM) image demonstrating a cross-section of the photonic crystal according to the invention. In actual application, the photonic crystal 10 is a porous silicon-based photonic crystal. Additionally, the photonic crystal 10 of present invention is prepared by (including but not limited to) a silicon-based material, a high polymer material, or a semiconductor material, such as: silicon, silicon dioxide, silicon nitride, titanium oxide, photoresist, polystyrene (PS), or polymethylmethacrylate (PMMA, Acrylic). The photonic crystal 10 of present invention comprises a plurality of voids 12, wherein each void is in nano-scale size, e.g., the diameter of voids can be 10 nanometer (nm). Moreover, the photonic crystal 10 can be a porous silicon-based photonic crystal which has layers with different void density. As shown in FIG. 3, the photonic crystal 10 can be a porous silicon-based photonic crystal which has 5 and a half layers with different void density. When the photonic crystal 10 is immersed in the liquids of different concentrations, the wavelength can be tuned in visible spectrum, wherein the liquids can be 0 to 99.5 wt % ethanol aqueous solutions, and the tunable range of wavelength is between 400 nm to 700 nm.

In actual application, the hydrophobic film 14 on the surface of each void 12 is a heptadecafluoro-1,1,2,2-tetrahydrodecyltrichlorosilane self-assembled monolayer formed by a molecular vapor deposition process.

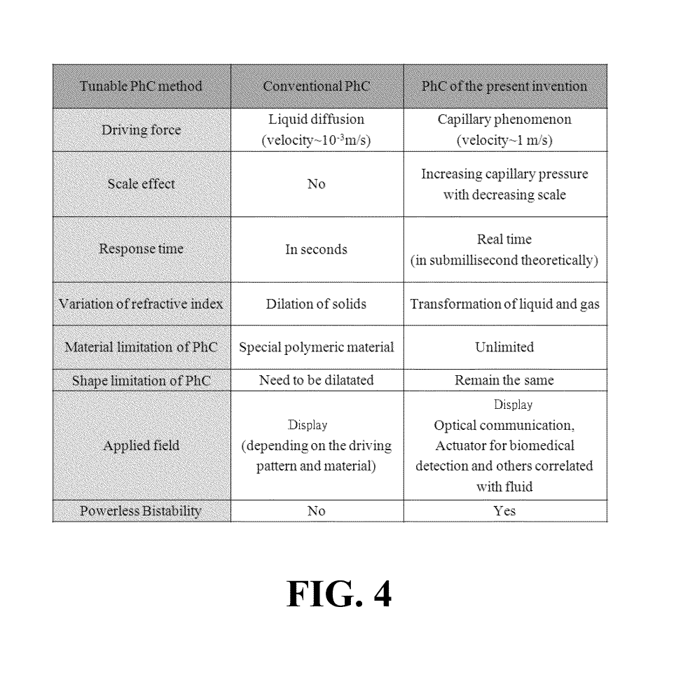

Please refer to FIG. 4. FIG. 4 is a comparison table illustrating the tunable photonic crystal (PhC) method. As shown in FIG. 4, the present invention has better performance than prior art, no matter in the aspects of driving force, scale effect, response time, variation of refractive index, material limitation, shape limitation, applied field, or powerless bistability.

Compared with conventional PhC, the photonic crystal of present invention applies the variation of capillary pressure generated by displacing different fluids to form the bidirectional flow for adjusting the liquid proportion within the voids. Meanwhile, the equivalent refractive index of the voids would be changed, and influencing the reflection and transmission spectra of photonic crystal, so that the color of photonic crystal can be changed widely and rapidly. Furthermore, owing to the energy barrier between the first and second stable states, the photonic crystal can remain at either of the two states without external power consumption.

The present invention makes a breakthrough in tunable photonic crystal method by displacing the liquid and gas to adjust the refractive index. Besides, the photonic crystal of present invention uses nano-capillary pressure as a driving force, making the velocity be 100 times faster than atmospheric pressure-driven method. In addition, the present invention also succeeds in coating the surface of voids with hydrophobic monolayer, meanwhile, forming the bidirectional flow for adjusting the liquid proportion within the voids with only 10 nm in diameter and 500 nm in depth.

In summary, the photonic crystal of present invention is the first one to achieve fast response time and wide tunable range of wavelength successfully, and meanwhile, remain at a stable state without external power consumption.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A bistable photonic crystal, comprising a plurality of voids, each surface of void having a hydrophobic film, the photonic crystal having a first stable state and a second stable state when the photonic crystal is immersed in a predetermined liquid, wherein the first stable state is to fill the plurality of voids with the predetermined liquid, and the second stable state is to exclude the predetermined liquid from the plurality of voids.

2. The photonic crystal of claim 1, wherein the photonic crystal comprises a surface, the first stable state is to fill the plurality of voids with the predetermined liquid by coating a first liquid on the surface of the photonic crystal, and the surface tension of the first liquid is less than the surface tension of the predetermined liquid.

3. The photonic crystal of claim 2, wherein the second stable state is to exclude the predetermined liquid from the plurality of voids by coating a second liquid on the surface of the photonic crystal, and the surface tension of the second liquid is greater than the surface tension of the predetermined liquid.

4. The photonic crystal of claim 3, wherein the predetermined liquid, the first liquid, and the second liquid can be binary liquid mixtures with different mass concentrations respectively.

5. The photonic crystal of claim 4, wherein the predetermined liquid, the first liquid, and the second liquid can be alcohol-water mixtures with different mass concentrations respectively.

6. The photonic crystal of claim 5, wherein the predetermined liquid can be a 30 wt % ethanol aqueous solution, the first liquid can be a 99.5 wt % ethanol aqueous solution, and the second liquid can be a pure water.

7. The photonic crystal of claim 1, wherein each void is in nano-scale size.

8. The photonic crystal of claim 1, wherein the hydrophobic film is a heptadecafluoro-1,1,2,2-tetrahydrodecyltrichlorosilane self-assembled monolayer.

9. The photonic crystal of claim 8, wherein the heptadecafluoro-1,1,2,2-tetrahydrodecyltrichlorosilane self-assembled monolayer is formed by a molecular vapor deposition process.

10. The photonic crystal of claim 1, wherein the photonic crystal is a porous silicon-based photonic crystal.

11. The photonic crystal of claim 1, wherein the predetermined liquid, the first liquid, and the second liquid can be a polar liquid or a nonpolar liquid.

12. The photonic crystal of claim 11, wherein the predetermined liquid, the first liquid, and the second liquid can be water, alcohols, colloids, surfactants, or ionic liquids.

13. The photonic crystal of claim 1, wherein the photonic crystal is prepared by a silicon-based material, a high polymer material, or a semiconductor material.

14. The photonic crystal of claim 13, wherein the photonic crystal is prepared by silicon, silicon dioxide, silicon nitride, titanium oxide, photoresist, polystyrene (PS), or polymethylmethacrylate (PMMA, Acrylic).
